(19) United States
(12) Patent Application Publication
(10) Pub. No.: US 2016/0318260 A1
(43) Pub. Date: Nov. 3, 2016

(54) PRINTING SYSTEMS AND RELATED METHODS

(71) Applicant: Elwha LLC, Bellevue, WA (US)

(72) Inventors: Roderick A. Hyde, Redmond, WA (US); Jordin T. Kare, San Jose, CA (US); Elizabeth A. Sweeney, Seattle, WA (US)

(21) Appl. No.: 14/700,743

(22) Filed: Apr. 30, 2015

(51) Int. Cl. B29C 67/00

(52) U.S. Cl. CPC B29C 67/0096; B29C 67/0055; B33Y 10/00

(57) ABSTRACT

Embodiments disclosed herein relate to a printing system configured to print a three-dimensional object on a region of interest. The printing system can include one or more flushing elements configured to dispense one or more flushing agents towards the region of interest to prepare the region of interest to have an object printed thereon. Other embodiment disclosed herein also relate to methods of using such printing systems.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 U.S.C. §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

Embodiments disclosed therein are directed to printing systems configured to print a three-dimensional object on a region of interest. In an embodiment, the printing systems include one or more flushing elements that dispense one or more flushing agents towards the region of interest to prepare the region of interest to have the three-dimensional object printed thereon.

In an embodiment, a printing system is disclosed. In an embodiment, the printing system includes at least one material reservoir configured to store one or more materials. The printing system further optionally includes one or more dispense elements coupled to the at least one material reservoir. The one or more dispense elements can include at least one dispense aperture. In an embodiment, the one or more dispense elements are configured to controllably dispense the one or more materials onto a region of interest. In an embodiment, the printing system also includes at least one flushing agent reservoir configured to store one or more flushing agents. In an embodiment, the one or more flushing agents are configured to prepare the region of interest to have the one or more materials dispensed thereon. Additionally, the printing system optionally includes one or more flushing elements coupled to the at least one flushing agent reservoir. In an embodiment, the one or more flushing elements include at least one flushing aperture. In an embodiment, the one more flushing elements are also configured to dispense one or more flushing agents through the at least one flushing aperture towards the region of interest. The printing system further optionally includes a controller that is operably coupled to at least the one or more dispense elements. In an embodiment, the controller includes control electrical circuitry that is configured to at least direct dispensing of the one or more materials from the one or more dispense elements.

In an embodiment, a method of using a printing system is disclosed. The method optionally includes positioning one or more flushing elements adjacent to or proximate to a region of interest. The one or more flushing elements optionally include at least one flushing aperture. The method also optionally includes dispensing one or more flushing agents through the at least one flushing aperture to prepare the region of interest to have one or more materials printed thereon. The method further optionally includes positioning one or more dispense elements adjacent to or proximate to the region of interest. In an embodiment, the one or more dispense elements includes at least one dispense aperture. Finally, the method optionally includes, responsive to direction from the control electrical circuitry, controllably dispensing the one or more materials from the one or more dispense elements onto the region of interest.

In an embodiment, a printing system is disclosed. In an embodiment, the printing system includes a body-insertable device configured to be inserted into a subject to access an internal region of interest therein. The printing system also optionally includes at least one material reservoir configured to store one or more materials. The printing system further optionally includes one or more dispense elements coupled to the at least one material reservoir. The one or more dispense elements optionally includes at least one dispense aperture. In an embodiment, the one or more dispense elements are configured to controllably dispense the one or more materials onto a region of interest. Additionally, the one or more dispense elements are at least partially positioned within the body-insertable device. In an embodiment, the printing system also includes at least one flushing agent reservoir configured to store one or more flushing agents. In an embodiment, the one or more flushing agents are configured to prepare the region of interest to have the one or more materials dispensed thereon. Additionally, the printing system optionally includes one or more flushing elements coupled to the at least one flushing agent reservoir. In an embodiment, the one or more flushing elements include at least one flushing aperture. In an embodiment, the one more flushing elements are configured to dispense one or more flushing agents through the at least one flushing aperture toward the region of interest. In an embodiment, the one or more flushing elements are at least partially positioned within the body insertable device. In an embodiment, the printing system further includes a controller that is operably coupled to at least the one or more dispense elements. In an embodiment, the controller includes control electrical circuitry that is configured to at least direct dispensing of the one or more materials from the one or more dispense elements.

In an embodiment, a reversibly attachable cartridge for a printing system is disclosed. The reversibly attachable cartridge optionally includes at least one flushing agent reservoir that is configured to store one or more flushing agents. In an embodiment, the one or more flushing agents are configured to prepare the region of interest to have the one or more materials dispensed thereon. In an embodiment, the reversibly attachable cartridge also includes one or more flushing elements that are coupled to the at least one flushing agent reservoir. In an embodiment, the one or more flushing elements include at least one flushing aperture. In an embodiment, the one or more flushing elements are configured to dispense one or more flushing agents through the at least one flushing aperture to prepare the region of interest to receive one or more materials dispensed from one or more dispense elements. Additionally, the reversibly attachable cartridge optionally includes one or more conduits fluidly coupling the at least one flushing agent reservoir with the one or more flushing elements. In an embodiment, the reversibly attachable cartridge further includes a housing that at least partially encloses the at least one flushing agent reservoir, the one or more flushing elements, and the one or more conduits. In an embodiment, the housing is further configured be communicably coupled to and reversibly attached to the printing system.

Features from any of the disclosed embodiments can be used in combination with one another, without limitation. In addition, other features and advantages of the present disclosure will become apparent to those of ordinary skill in the art through consideration of the following detailed description and the accompanying drawings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic cross-sectional view of a printing system according to an embodiment.

FIG. 2 is a flow diagram of a method of using the printing system illustrated in FIG. 1 according to an embodiment.

FIG. 3 is a schematic cross-sectional view of a printing system according to an embodiment.

FIG. 4 is a flow diagram of a method of using the printing system illustrated in FIG. 1 according to an embodiment.

FIG. 5 is a schematic cross-sectional view of a printing system according to an embodiment.

FIG. 6 is a schematic cross-sectional view of a printing system configured to be inserted into an internal region of a body of a subject according to an embodiment.

FIG. 7 is schematic cross-sectional view of a printing system that includes at least one reversibly attachable cartridge according to an embodiment.

### DETAILED DESCRIPTION

Embodiments disclosed therein are directed to printing systems configured to print a three-dimensional object on a region of interest using one or more flushing elements dispense one or more flushing agents towards the region of interest. The one or more flushing agents prepare the region of interest to have the three-dimensional object printed thereon. The one or more flushing elements can be coupled to at least one flushing agent reservoir configured to store the one or more flushing agents. The one or more flushing agents can include one or more cleaning agents, one or more antimicrobial agents, one or more sterilizing agents, or one or more corrosive agents, etc. In some embodiments, the one or more flushing elements can be coupled to one or more elongated members, coupled to a printing head, partially enclosed by the printing head, or incorporated into the printing head. The printing system can also include one or more dispense elements configured to controllably dispense one or more materials onto the region of interest.

For example, the region of interest can include a wound (e.g., a dermal wound or internal wound) and the printing system can print in situ a scaffold and a bioink including cells and extracellular components to form a tissue graft. For example, in an orthopedic surgical intervention, the printing system can print a polymer scaffold and a bioink including osteocytes to provide a bone graft. For example, when the region of interest is an internal anatomical site, the printing system can print a scaffold suitable for colonization of endogenous cells or tissues. For example, when the region of interest includes an intra-abdominal site, the printing system can print all or part of an organ, (e.g., a liver), which can include vascular or microvasculare structures. For example, when the internal site includes a solid tumor, the printing system can print a covering of a bioink including a hydrogel and a compound mixture including chemotherapeutics and vascular inhibitors. For example, in an intravascular procedure, the printing system can print a filler for an aneurysm. In an embodiment, the printing system is suited for printing complex patterns. For example, in a cardiovascular procedure, the printing system can print a patterned cardiac patch directly onto heart tissue, e.g., to support or repair a damaged heart, the patch including a material having a bioink of elastic hydrogel and a second bioink including cardiomyocytes. For example, the printing system can print onto a region of interest that includes a substrate, biocompatible structures having complex patterns from bioinks including one or multiple structural compounds forming a scaffold and additional bioinks having cells of interest with supportive compounds. These biocompatible structures can be incubated ex vivo, e.g., for cell growth, for use in in vivo procedures. For example, the printing system can print on a region of interest that is an external surface of a body of a living subject, such as the skin, an eye, or an open wound. For example, in a region of interest including a weakened site on a nonorganic surface, such as a joint in a plumbing line, the printing system can print a supportive patch including an adhesive. For example, in a region of interest including a plant tissue having an abrasion, a printing surface might print a plant graft to aid in healing or to introduce a heterogeneous plant to form a hybrid.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here.

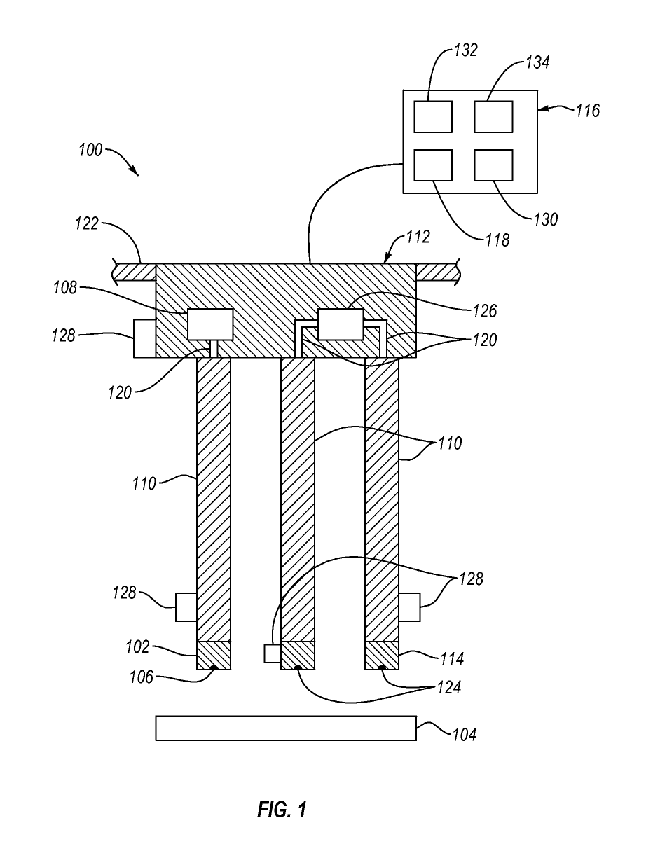

FIG. 1 is a schematic cross-sectional view of a printing system 100 according to an embodiment. The printing system 100 includes one or more flushing elements 102 configured to dispense one or more flushing agents towards the region of interest 104. Each of the one or more flushing elements 102 includes at least one flushing aperture 106 configured to dispense one or more flushing agents therethrough towards the region of interest 104. The one or more flushing agents 102 prepare the region of interest 104 to have a three-dimensional object printed thereon. The one or more flushing elements 102 can be coupled to at least one flushing agent reservoir 108 configured to store the one or more flushing agents therein. The one or more flushing elements 102 can also be coupled to one or more elongated members 110. In an embodiment, the one or more elongated members 110 can include one or more actuators that controllably move the one or more elongated members 110. The one or more elongated members 110 can be operably coupled to and extend from a printing head 112. The printing system 100 can also include a printing device. The illustrated printing device includes one or more dispense elements 114 also coupled to one or more elongated members 110. The one or more dispense elements 114 controllably dispense one or more materials onto the region of interest 104. Additionally, the printing system 100 further includes a controller 116 having control electrical circuitry 118. The control electrical circuitry 118 can controllably steer the one or more elongated members 110 and, consequently, the one or more dispense elements 114 to controllably dispense the one or more materials from the one or more dispense elements 114.

As discussed above, the one or more flushing elements 102 are configured to dispense one or more flushing agents. For example, the one or more flushing elements 102 are configured to dispense the one or more flushing agents towards the region of interest 104, such as towards the region of interest 104 or an at least partially printed object printed thereon. The one or more flushing elements 102 can receive the one or more flushing agents via one or more inlets or can store the one or more flushing agents in a flushing agent reservoir included therein. Each of the one or more flushing elements 102 includes at least one flushing aperture 106 configured to dispense one or more flushing agents. The one or more flushing elements 102 are positioned to dispense the one or more flushing agents proximate to or adjacent to a specific segment of the region of interest 104. In an embodiment, the one or more flushing elements 102 can controllably dispense the one or more flushing agents responsive to one or more directions from the control electrical circuitry 118. In an embodiment, the one or more flushing elements 102 can dispense the one or more flushing agents without direction from the control electrical circuitry 118. For example, a user can manually open one or more valves (e.g., on a compressed gas tank) that allows the one or more flushing elements 102 to dispense one or more flushing agents (e.g., compressed gas).

The one or more flushing agents can include any physical, biological, or chemical agent that prepares the region of interest 104 to have an object printed thereon. The region of interest 104 can be any location that the printing system 100 is configured to print on. In an embodiment, the region of interest 104 can include a non-organic region of interest 104, such as a metal, a ceramic, a polymer, a composite, a micro-material, a nano-material, a liquid, or other non-organic material. In an embodiment, the region of interest 104 can include an organic or biological region of interest 104, such as organic scaffolding, a bone, a wound, a vein, skin, or another organic material. In an embodiment, the region of interest 104 can include a plant, such a leaf, a stem, a root, bark (e.g. outer bark, inner bark), phloem, vascular cambium, sapwood, or heartwood, etc.

Each of the one or more flushing elements 102 includes the at least one flushing aperture 106 that dispenses the one or more flushing agents therethrough. The one or more flushing elements 102 can include one or more microconduits, one or more nozzles, or one or more tubes, each of which includes at the at least one flushing aperture 106. The one or more flushing elements 102 can dispense the one or more flushing agents using any suitable method, such as spraying the one or more flushing agents, forming droplets of the one or more flushing agents, or streaming the one or more flushing agents. In an embodiment, the one or more flushing elements 102 can include a disk having at least one flushing aperture 106 therein. The size of the at least one flushing aperture 106 can be configured to dispense the one or more flushing agents at a specific rate or dispense the one or more flushing agents at a certain velocity. The disk can be configured to dispense the one or more flushing agents. In an embodiment, the disk can be formed of a biocompatible material, an oxidation-resistant material, a corrosive-resistant material and/or a material having a high operating temperature if the disk is heated. In an embodiment, the disk can include a relatively stiff material that can form a droplet having a slower exit velocity (e.g., the velocity of a droplet immediately after separating from the at least one flushing aperture 106).

The one or more flushing elements 102 can dispense the one or more flushing agents at a number of angles. In an embodiment, the one or more flushing elements 102 can dispense the one or more flushing agents at an angle that is substantially perpendicular to the region of interest 104. In an embodiment, the one or more flushing elements 102 can dispense the one or more flushing agents at non-perpendicular angle relative to the region of interest 104. For example, the one or more flushing elements 102 can dispense the one or more flushing agents onto a substantially nonplanar region of interest 104. In an embodiment, the angle at which the one or more flushing elements 102 dispense the one or more flushing agents can change if the one or more flushing elements 102 are moved or steered, for example by control electrical circuitry. In an embodiment, the one or more flushing elements 102 can include a plurality of flushing apertures 106, each of which are configured to dispense the one or more flushing agents at different angles.

The one or more flushing elements 102 can be heated during use. In an embodiment, the one or more flushing elements 102 can be heated if a selected property of the flushing agent requires elevated temperatures (e.g., boiling water, lower viscosity). In an embodiment, the one or more flushing elements 102 can be heated if a desired phase of a flushing agent is not stable at operating temperatures (e.g., vaporized hydrogen peroxide, steam). As such, the one or more flushing elements 102 can include a heat source attached thereto or incorporated therein. The one or more flushing elements 102 can include a thermal shield (not shown) that prevents or minimizes heat dissipated from the heat source to the region of interest 104.

In an embodiment the one or more flushing elements 102 can include an electrical source (not shown) attached thereto or incorporated therein. For example, the one or more flushing elements 102 can include an electrical source configured to, just prior to or at the time of dispensing, alter a state of the flushing agent (e.g., to electrolyze saline to create a disinfectant such as superoxidized water for use in disinfecting a biological region of interest 104).

In an embodiment, at least one of the one or more flushing elements 102 can receive the one or more flushing agents via one or more inlets, at least one flushing agent reservoir 108 located therein, or combinations thereof. For example, at least one flushing element 102 can include a single inlet or a single flushing agent reservoir 108. As such, the at least one flushing element 102 can receive only a single flushing agent (e.g., a mixture of flushing agents) at any time. The at least one flushing element 102 can include at least one flushing aperture 106, such as two or more flushing apertures 106, configured to dispense the single flushing agent. The two or more flushing apertures 106 can enable the one or more flushing elements 102 to dispense the single flushing agent at a greater rate, towards multiple locations simultaneously, or using a different method (e.g., spraying and forming droplets). In an embodiment, one or more flushing elements 102 can receive one or more flushing agents via one or more inlets or at least one flushing agent reservoir 108 holding the one or more flushing agents therein that is fluidly coupled to the at least one flushing element 102. The at least one flushing element 102 can include a plurality of flushing apertures 106, with each of the plurality of flushing apertures 106 dispensing different flushing agents or the same flushing agent substantially simultaneously.

The one or more flushing elements 102 can be configured to operate in a number of environments. In an embodiment the printing system 100 prints a biological material in an ex vivo, an in vivo, or an in vitro environment. As such, the one or more flushing elements 102 can include a biocompatible material or be configured to operate in a fluid (e.g., blood, interstitial fluids). In an embodiment the printing system 100 prints a material in an oxidizing environment. As such, the one or more flushing elements 102 can include an oxidation-resistant material. In an embodiment, the printing system 100 can be configured to operate in a dry or moist environment. Additionally, the one or more flushing elements 102 can be formed of a material suitable for dispensing the one or more flushing agents. For example, the one or more flushing elements 102 can be formed of an abrasive-resistant material if the flushing agent includes abrasive particles. In another example, the one or more flushing elements 102 can be formed of a corrosive-resistant material if the flushing agent includes a corrosive agent.

The one or more flushing elements 102 can include a device that controllably dispenses the one or more flushing agents. In an embodiment, the one or more flushing elements 102 can include a valve, such as a pneumatic-actuated valve, an electrically actuated valve, a solenoid valve, or a mechanically actuated valve. In an embodiment, the one or more flushing elements 102 may include a pump, a compressor, or a piezoelectric configured to create pressure gradients that dispense the one or more flushing agents from the one or more flushing elements 102. In an embodiment, the control electrical circuitry 118 can direct the value, pump, compressor, or piezoelectric to control the amount or rate at which the one or more flushing agents are dispensed from the one or more flushing elements 102.

The one or more flushing elements 102 can dispense one or more flushing agents stored in the at least one flushing agent reservoir 108. The at least one flushing agent reservoir 108 can be coupled (e.g., fluidly coupled) to the one or more flushing elements 102. The at least one flushing agent reservoir 108 can be configured to supply the one or more flushing agents to the one or more flushing elements 102. For example, the at least one flushing agent reservoir 108 can include a pump or compressor that moves the one or more flushing agents from the at least one flushing agent reservoir 108 to the one or more flushing elements 102. The at least one flushing agent reservoir 108 can be reusable, refillable, or replaceable. Additionally, the at least one flushing agent reservoir 108 can include one or more compartments therein. Each of the compartments can store substantially similar flushing agents or substantially different flushing agents.

The at least one flushing agent reservoir 108 can store a variety of flushing agents. In an embodiment, the at least one flushing agent reservoir 108 can store one or more cleaning agents. The one or more cleaning agents can be any flushing agents that are configured to remove one or more substances from the region of interest 104. For example, the one or more cleaning agents can include a surfactant cleaning compound (e.g., soap). In an embodiment, the one or more cleaning agents can include pressurized air that blows one or more substances from the region of interest 104. In an embodiment, the one or more cleaning agents can include air or other gas that removes moisture from and dries the region of interest 104. In an embodiment, the one or more cleaning agents can include a vacuum that is configured to suck-up one or more substances from the region of interest 104. In an embodiment, the one or more cleaning agents can include particles, such as abrasive particles, configured to blast the one or more substances away from the region of interest 104.

In an embodiment, the one or more flushing agents can include one or more antimicrobial agents. The one or more antimicrobial agents can be configured to partially or completely destroy or inhibit microorganisms that are living on the region of interest 104. In an embodiment, the one or more antimicrobial agents can include one or more disinfectant agents that are configured to destroy microorganisms living on a non-living object. For example, the one or more disinfectant agents can include air disinfectants (e.g., glycols), alcohols, aldehydes, oxidizing agents, phenolics, quaternary ammonium compounds (quats), ethylene oxide, or other suitable disinfectants. In an embodiment, the one or more antimicrobial agents can include one or more antibiotic agents that are configured to inhibit or kill microorganisms within a living organism. The one or more antibiotic agents can include bactericidal agents, bacterial inhibitors, bacteriostatic agents, narrow-spectrum antibiotics, broad-spectrum antibiotics, cyclic lipopeptides, glycylcyclines, oxazolidinones, or lipiarmycins. In an embodiment, the one or more antimicrobial agents can include one or more antiseptic agents configured to destroy microorganisms on living tissue. Examples of antiseptic agents include alcohols, iodine, cationic surfactants, phenol, hydrogen peroxide, superoxidized water, saline solutions, polyhexanide, or another suitable antiseptic agent.

In an embodiment, the one or more flushing agents can include one or more sterilizing agents configured to destroy microorganisms in all stages, including bacteria, viruses, fungi, yeast, spores and the like. In an embodiment, the one or more sterilizing agents can include a physical process. For example, the one or more sterilizing agents can irradiate the region of interest 104. The one or more sterilizing agents can irradiate the region of interest 104 using heat or light. Alternatively, the one or more sterilizing agents can sterilize the region of interest 104 using a heated liquid, such as steam or vaporized hydrogen peroxide. The one or more sterilizing agents can sterilize the region of interest 104 using sound waves, for example ultrasound waves. In an embodiment, the one or more sterilizing agents can include a chemical or biological agent configured to destroy microorganisms. For example, the one or more sterilizing agents can include ethyl oxide, nitrogen dioxide, ozone, bleach, hydrogen peroxide, alcohols (e.g., ethanol), iodine, peracetic acid, sodium hydroxide, sodium hypochlorite, hydrogen sulfite, glutaraldehyde, or other suitable sterilizing agents.

In an embodiment, the one or more flushing agents can include one or more biocidal agents. The one or more biocidal agents can be configured to destroy substantially all living matter on the region of interest 104. In an embodiment, the one or more biocidal agents can include a physical process such as those described above, for example, at a higher intensity, a different frequency, or a longer duration than can be used for sterilization. In an embodiment, the one or more biocidal agents can include a chemical or biological agent configured to destroy the living matter. For example, the one or more biocidal agents can include ethyl oxide, nitrogen dioxide, ozone, bleach, hydrogen peroxide, alcohols (e.g., ethanol), iodine, peracetic acid, sodium hydroxide, sodium hypochlorite, hydrogen sulfite, or other suitable biocidal agents. For example, the one or more biocidal agents can include sterilizing agents prepared at higher concentrations or dispensed for longer duration.

In an embodiment, the one or more flushing agents can include one or more agents that degrade or destroy organic matter on the region of interest 104. For example, organic matter can include living tissue, living organisms, contaminants, cellular compositions, cellular products, prions, peptides, protein, lipid, glycoside, or nucleic acid. In an embodiment, the one or more agents can include a chemical or biological agent configured to destroy organic matter. For example, the one or more flushing agents can include an enzyme, a strong base, a strong acid, an oxidizing compound, or an ablative compound. In an embodiment, the one or more agents for destroying organic matter can include a physical process. For example, the one or more agents can act as a plasma treatment, an electrical treatment, or a thermal treatment.

In an embodiment, the one or more flushing agents can include one or more corrosive agents that damage or destroy one or more substances on the region of interest 104. For example, the one or more corrosive agents can include one or more oxidizing agents such as air, oxygen, hydrogen peroxide, super-oxidized water, nitrogen dioxide or another suitable oxidizing agent. The one or more oxidizing agents can provide an oxidizing environment during the printing process. The one or more corrosive agents can also include acidic solutions, basic solutions, or other corrosive agents. In an embodiment, the region of interest 104 can include a silicon substrate. The one or more flushing element 102 can dispense hydrofluoric acid onto the silicon substance to remove any silicon oxide therefrom. Alternatively, the one or more flushing elements 102 can dispense an oxidizing agent onto the silicon substrate to form a silicon oxide layer. The one or more corrosive agents can also be used to destroy microorganisms or living material.

In an embodiment, the one or more flushing agents can include one or more inert agents configured to provide an inert atmosphere. The one or more inert agents can include argon, other noble gas, carbon dioxide, nitrogen, or other inert gaze. Alternatively, the one or more inert agents can include a partial vacuum proximate to the region of interest 104. The vacuum can also minimize the amount of flushing agents, such as toxic flushing agents, that dissipate from the region of interest 104. In an embodiment, the flushing agent can include a liquid absorption material, medicament, a non-stick material (e.g., oil), a binder (e.g., an adhesive), a saccharide solution, a lipid solution, a detergent or other materials that can prepare the region of interest 104.

In an embodiment, the one or more flushing agents can prevent an object printed on the region of interest 104 from being contaminated. For example, the one or more flushing agents can remove or destroy potential contaminates. In an embodiment, the one or more flushing agents can facilitate bonding of the object to the region of interest 104. For example, the one or more flushing agents can remove or destroy substances that prevent bonding of the object to the region of interest 104. Alternatively, the one or more flushing agents (e.g., a non-stick material) can prevent the object from bonding to the region of interest 104. In an embodiment, the one or more flushing agents can change the region of interest 104 (e.g., oxidize) to facilitate bonding of the object to the region of interest 104. In an embodiment, the one or more flushing agents can prevent infection, sepsis, or putrefaction. In an embodiment, the one or more flushing agents can improve the precision of the printing system 100 by removing substances that can affect the precision of the printing system 100 (e.g., bumps). In an embodiment, the one or more flushing agents can be configured to cause (e.g., oxidizing environment) or prevent (e.g., inert environment) a chemical reaction from occurring when the object is printed.

In some embodiments, the one or more flushing agents can be used in a living organism. As such, the one or more flushing agents can be biocompatible and non-toxic. In an embodiment, the one or more flushing agents can be used on a non-organic material. Flushing agents used on non-organic materials do not have to be biocompatible or non-toxic.

In an embodiment, the one or more flushing agents are flushing liquids, flushing gases, or flushing solids. Flushing liquids can include water (e.g., super-oxidized water), saline solutions, saccharide solutions, peroxide solutions, superoxidized solutions, glutaraldehyde, alcohol solutions, bleach solutions, basic solutions, acidic solutions, medicament, or other liquid flushing agents. Flushing gases can include air, oxygen, nitrogen, argon, carbon dioxide, vaporized hydrogen peroxide, ozone, nitrogen dioxide, ethylene oxide, or other gaseous flushing agent. Flushing solids can include liquid absorption materials, binders, or other solid flushing agents.

In an embodiment, the one or more flushing agents can include two or more flushing agents that work in conjunction with each other. For example, the one or more flushing elements 102 dispense one or more liquid absorption materials onto the region of interest 104. Afterwards, the one or more flushing elements 102 dispense one or more cleaning agents, such as compressed air, that removes the one or more liquid absorption materials from the region of interest 104. In an embodiment, the one or more flushing elements 102 dispense one or more toxic flushing agents (e.g., hydrofluoric acid) onto the region of interest 104. Afterwards, the one or more flushing element 102 can dispense a cleaning agent onto the region of interest 104 to remove the one or more toxic flushing agents.

The at least one flushing reservoir 108 can be formed of a material configured to stably store the one or more flushing agents. In an embodiment, the one or more flushing agents can include one or more corrosive agents. As such, the at least one flushing agent reservoir 108 can include a non-corrosive material. For example, a flushing agent reservoir 108 configured to store hydrofluoric acid can include a plastic material or a suitable stainless steel. In an embodiment, the one or more flushing agents can include abrasive particles. As such, the flushing agent reservoir 108 can include a wear-resistant material, such as a suitable stainless steel or a ceramic. In an embodiment, the flushing agent can include a compressed fluid. In such an embodiment, the flushing agent reservoir 108 can include a pressure vessel.

The at least one flushing agent reservoir 108 can be coupled to the one or more flushing elements 102 via one or more conduits 120. The one or more conduits 120 can be coupled to an outlet (not shown) of the at least one flushing agent reservoir 108 and an inlet (not shown) of the one or more flushing elements 102. In an embodiment, the one or more conduits 120 can include a tube. Additionally, the one or more conduits 120 can include one or more components to facilitate the flow of the one or more flushing agents therethrough, such as a pump. For example, the one or more conduits 120 can extend through the one or more elongated members 110.

The at least one flushing agent reservoir 108 can be configured to move the one or more flushing agents from the at least one flushing agent reservoir 108 to the one or more flushing elements 102. In an embodiment, the at least one flushing agent reservoir 108 can include or be associated with a component, such as a pump, that moves the one or more flushing agents from the at least one flushing agent reservoir 108. The component can operate responsive to a direction received from the control electrical circuitry 118. In an embodiment, the at least one flushing agent reservoir 108 can include a collapsible bag that exerts a compressive pressure on the one or more flushing agents therein. Alternatively, the at least one flushing agent reservoir 108 can use gravity or another component of the printing system 100 (e.g., the one or more flushing elements 102 can include a pump) to move the one or more flushing agents. Similarly, the at least one flushing agent reservoir 108 can include a valve that prevents the one or more flushing agents from leaving the at least one flushing agent reservoir 108.

In the illustrated embodiment, the at least one flushing agent reservoir 108 is positioned in and at least partially enclosed by the printing head 112. However, in an embodiment, the at least one flushing agent reservoir 108 can be positioned at other locations of the printing system 100. For example, at least one flushing agent reservoir 108 can be attached to an exterior of the printing head 112. In an embodiment, the at least one flushing agent reservoir 108 can be positioned in or attached to the one or more elongated members 110 or the one or more flushing elements 102. In an embodiment, the at least one flushing agent reservoir 108 can include two or more flushing agent reservoirs coupled together and spaced from each other (e.g., a primary flushing agent reservoir and a secondary flushing agent reservoir). In an embodiment, the at least one flushing agent reservoir 108 can be located remote from the printing system 100. For example, the flushing agent reservoir 108 can include a compressed gas tank that is remote from the printing system 100. The compressed gas tank can be connected to the printing system 100 using a tube.

In the illustrated embodiment, the one or more flushing elements 102 are coupled to one or more elongated members 110. The one or more elongated members 110 can be configured to support the one or more flushing elements 102 adjacent to or proximate to the region of interest 104. Each of the one or more elongated members 110 can include a single flushing element 102 or a plurality of flushing elements 102 coupled thereto. In an embodiment, the printing system 100 can include about 1 to about 10 elongated members 110, each of which are coupled to a corresponding one of the one or more flushing elements 102. In some complex printing operations, the printing system 100 can include more than 10 elongated members 110. The number of elongated members 110 included in the printing system 100 can depend on the specific printing operation. For example, increasing the number of elongated members 110 can enable the printing system 100 to prepare the region of interest 104 for more complex printing operations.

In an embodiment, the one or more elongated members 110 can merely support the one or more flushing elements 102 proximate or adjacent the region of interest 104. For example, the one or more elongated members 110 can include a rigid, semi-rigid, or flexible material. In an embodiment, the one or more elongated members 110 can include one or more actuators that move the one or more elongated members 110. For example, the one or more elongated members 110 can include a rigid material and an actuator attached to the rigid material. The one or more actuators can include a pneumatic actuator, a hydraulic actuator, a piezoelectric actuator, a shape memory material actuator, or an electroactive polymer actuator. For example each of the elongated members 110 can include a single actuator, an actuator couple to another actuator, any combinations of actuators, any number of actuators, or an actuator coupled to a portion of the elongated member 110 that is not configured to move (e.g., a rigid material). The elongated members 110 can be steerable in one or more directions. The one or more actuators enables the printing system 100 to controllably steer the one or more flushing elements 102 to selectively position the one or more flushing elements 102. For example, the one or more elongated members 110 can move the one or more flushing elements 102 adjacent to a specific segment of the region of interest 104 such that the one or more flushing elements 102 can prepare the specific segment of the region of interest 104 to have an object printed thereon. In an embodiment, the one or more elongated members 110 can steer the one or more flushing elements 102 adjacent to an at least partially printed object such that the one or more flushing elements 102 can dispense one or more flushing agents towards the at least partially printed object. In an embodiment, the one or more actuators can controllably steer the one or more flushing elements 102 responsive to direction from the control electronic circuitry 118.

In an embodiment, the one or more elongated members 110 can be configured to not controllably steer the one or more flushing elements 102, while the printing system 100 is printing an object on the region of interest 104. Such an embodiment can minimize the likelihood that the one or more elongated members 110 shake the printing system 100 during the printing operation, thereby increasing precision of the printing system 100. Alternatively, the one or more elongated members 110 can controllably steer the one or more flushing elements 102, while the printing system 100 prints the object. For example, the one or more elongated members 110 can controllably steer the one or more flushing elements 102 to dispense one or more flushing agents towards the at least partially printed object.

The one or more elongated members 110 may controllably steer the one or more flushing elements 102 responsive to direction from the control electrical circuitry 118. For example, the one or more elongated members 110 can include an electroactive polymer actuator. The electroactive polymer can include at least one capacitor applied to a surface thereof. Direction from the control electrical circuitry 118 can cause the capacitor to apply an electric field to the electroactive polymer, thereby causing the electroactive polymer to be controllably steered. In an embodiment, the one or more elongated members 110 can include a shape memory material actuator. The printing system 100 can include a device configured to apply heat to the shape memory actuator. The device can heat the shape memory material actuator responsive to direction from the control electrical circuitry 118.

The one or more elongated members 110 can be configured to be controllably steered independently of each other. As such, each of the elongated members 110 can move independently of another elongated member 110. For example, each of the one or more elongated members 110 can be configured to receive one or more directions from the control electrical circuitry 118 containing instructions. The specific instructions can direct each of the one or more elongated members 110 to actuate differently. In an embodiment, the one or more elongated members 110 can include a first actuator that moves in the z-direction and a second actuator that moves in the x-direction or y-direction. As such, each of the two actuators can be independently steerable. However, in an embodiment, at least some of the one or more elongated members 110 cannot move independently. For example, two or more elongated members 110 can be rigidly or semi-rigidly attached together or each elongated member 110 can receive the same direction from the control electrical circuitry 118.

Additional examples of actuators that can form at least a portion of the elongated members 110 can be found in U.S. patent application Ser. No. 14/664,405 filed on 20 Mar. 2015, the disclosure of which is incorporated herein, in its entirety, by this reference.

Similar to the one or more flushing elements 102, the one or more elongated members 110 can be configured to operate in one or more different environments. In an embodiment, the one or more elongated members 110 can operate in a biological environment (e.g., an ex vivo, an in vivo, or an in vitro environment). As such, at least the exterior of the one or more elongated members 110 can include biocompatible materials. Biocompatible materials can include stainless steel, titanium, cobalt alloys, titanium alloys, ceramics, silicones, polyethylene, polyvinylchloride, or polyurethane. Additionally, the one or more elongated members 110 can be configured to operate in a liquid, such as blood or an interstitial fluid. In an embodiment, the one or more elongated members 110 can operate in an oxidizing or corrosive environment. As such, at least the exterior of the one or more elongated members 110 can include an oxidation-resistant material or a corrosive-resistant material. For example, the oxidation resistant material or the corrosive resistant material can include stainless steel, titanium, or cobalt alloys. In an embodiment, the one or more elongated members 110 can have a coating applied thereto that enables the one or more elongated members 110 to operate in the different environments.

The one or more elongated members 110 can support the one or more conduits 120. In an embodiment, the one or more conduits 120 can be attached to an exterior of the one or more elongated members 110 using, for example, a clamp. In an embodiment, the one or more elongated members 110 are at least partially hollow such that the one or more conduits 120 can be positioned within, defined by, partially enclosed in, or incorporated into the hollow portions of the one or more elongated members 110. For example, the one or more elongated members 110 can be formed of a hollow electroactive polymer. Alternatively, the one or more conduits 120 can be remote from the one or more elongated members 110.

As discussed above, the printing system 100 can further include the printing head 112 that is configured to support the components of the printing system 100. For example, the one or more elongated members 110 can be coupled to and extend from the printing head 112. The printing head 112 can also support the one or more elongated members 110 and the one or more flushing elements 102 above, proximate to, or adjacent to the region of interest 104. The printing head 112 can further include additional components mounted to, supported by, or at least partially enclosed by the printing head 112. For example, the at least one flushing agent reservoir 108 can be at least partially enclosed by the printing head 112. Additionally, the printing head 112 can include devices that actuate the one or more elongated members 110 (e.g., a compressor that actuates a pneumatic actuator).

The printing system 100 can further include a support structure 122 configured to support the printing head 112 a selected distance from the region of interest 104. For example, the support structure 122 can include one or more beams, columns, stretchers, or other structure coupled to the printing head 112 that maintain the printing head 112 above the region of interest 104. The support structure 122 can be further configured to maintain the printing head 112 substantially stable (i.e. does not uncontrollably tilt or shift) above the region of interest 104. For example, the support structure 122 can include two or more beams to which the printing head 112 can be attached or rest on. In an embodiment, the support structure 122 can include a single beam to which the printing head 112 can be rigidly attached. In such an embodiment, the printing head 112 can include a clamp, pin, bracket, or other suitable attachment that rigidly attaches the printing head 112 to the support structure 122.

In an embodiment, the printing system 100 can be configured to enable the printing head 112 to move in at least one, at least two, or three dimensions. For example, portions of the support structure 122 can include means for movement, while additional portions of the support structure 122 can include a track on which the potions of the support structure 122 move. Means for movement can include, for example, a motor, gears, gravity, one or more pneumatic actuators, one or more hydraulic actuators, or other means for movement. The means for movement can move the printing head 112 from a first location remote from the region of interest 104 to a second location proximate to the region of interest 104. Additionally, in the second location, the one or more flushing elements 102 can be positioned adjacent to or proximate to the region of interest 104. The support structure 122 can move the printing head 112 from the first position to the second position responsive to a signal or direction from the control electrical circuitry 118. The support structure 122 can be configured to move from the first location to the second location without contacting the printing head 112, the one or more flushing elements 102, or another component of the printing system 100 against an object. For example, the support structure 122 can include at least sensor that can detect an object and the control electrical circuitry 118 can use the data from the at least one sensor to move the printing head 112 around the object.

The support structure 122 can be configured to move the printing head 112 using a variety of techniques. In an embodiment, portions of the support structure 122 can be configured to rotate about an axis to thereby controllably tilt the printing head 112. For example, when the support structure 122 includes one shaft, the one shaft can rotate or twist, thereby tilting the printing head 112. In an embodiment, when the support structure 122 includes two shafts, one or more of the two shafts can rotate about an axis, thereby tilting the printing head 112. In an embodiment, portions of the support structure 122 can be configured to shift in at least one direction (e.g., at least one of the x-direction, y-direction, or z-direction), thereby displacing the printing head 112. For example, the support structure 122 can include two beams that are generally perpendicular to each other, where the first beam extends in the x-direction and the second beam extends in the y-direction. The first beam can be configured to move in the y-direction and the second beam can be configured to move in the x-direction. The support structure 122 can include tracks that enable the two beams to move in their respective directions. In such an embodiment, the printing head 112 can be attached to the two shafts using two or more bearings at a location about the intersection of the two beams. Such a configuration can permit the printing head 112 to be displaced along the first shaft (i.e., the x-direction) when the second shaft is moved in the x-direction, and vice-versa. Additionally, the support structure 122 can include an actuator configured to move the tracks in the z-direction, such as a hydraulic actuator. As such, the support structure 122 can move the printing head 112 in the x-direction, y-direction, and z-direction.

In an embodiment, the printing head 112 can be configured to move from the first position to the second position. For example, the printing head 112 can be attached to the support structure 122 using a bearing or other suitable attachment that enables the printing head 112 to move along the support structure 122. Additionally, the printing head 112 can include a motor attached to a wheel, a gear or a drive shaft that controllably moves the printing head 112 along the support structure 122. In an embodiment, both the support structure 122 and the printing head 112 can be configured to move the printing head 112 from the first position to the second position. For example, the support structure 122 can include one or more beams extending in the y-direction that are movable in the x-direction. The printing head 112 can configured to move along the beam in the y-direction.

In an embodiment, the printing system 100 can be configured to maintain the printing head 112 substantially stationary while the one or more flushing elements 102 dispense the one or more flushing agents. Such an embodiment can improve the stability of the printing system 100 and increase controllability of the one or more elongated members 110. In an embodiment, the printing head 112 can be maintained substantially stationary by the controller 116 by not intentionally directing the printing head 112 or the support structure 122 to move. For example, the printing head 112 can include a motor that is powered off to maintain the printing head 112 substantially stationary. In an embodiment, the printing system 100 can include a device that prevents the printing head 112 from substantially moving during the printing process. The device can include a clamp, pin, or brake that is configured to substantially prevent the printing head 112 or the support structure 122 from moving. The device can be activated by the controller 116 prior to or when the printing system 100 dispenses the one or more materials. In an embodiment, the printing head 112 is configured to move while the one or more flushing elements 102 dispense the one or more flushing agents.

In an embodiment, the printing system 100 can include a plurality of printing heads 112. Each of the plurality of printing heads 112 can include one or more elongated members 110 operably coupled to and extending from the printing head 112. At least some of the plurality of printing heads 112 can be rigidly or semi-rigidly coupled together. In an embodiment, at least some of the plurality of printing heads 112 can move independently from each other 106. For example, each of the plurality of printing heads 112 can include a corresponding motor configured to move a corresponding printing head 112. In an embodiment, different portions of the support structure 122 can be attached to each of the plurality of printing heads 112. As such, when each of the different portions of the support structure 122 shifts, twists, or otherwise moves, the attached printing head 112 correspondingly moves. At least some of the plurality of printing heads 112 can be substantially similar or substantially different from each other. Some of the one or more printing heads 112 can be configured to dispense different materials, print different objects substantially simultaneously, or print different portions of the object substantially simultaneously.

The printing system 100 can include one or more components that form a printing device configured to print an object on the region of interest 104. The printing device can be configured to print the object in situ. The printing device can be incorporated into the printing head 112, coupled to the printing head 112, or can operate in conjunction with the printing head 112. In an embodiment the printing device can be a specialized device as described herein or other suitable 3-D printing device.

In the illustrated embodiment, the printing device includes one or more elongated members 110 coupled to and extending from the printing head 112 towards the region of interest 104. The printing device further includes one or more dispense elements 114 coupled to the one or more elongated members 110. The one or more elongated members 110 can include one or more actuators that controllably steer the one or more dispense elements 114. The one or more dispense elements 114 can include at least one dispense aperture 124 configured to dispense one or more materials onto the region of interest 104. The one or more elongated members 110 can be controllably steered and the one or more dispense elements 114 can controllable dispense responsive to direction from the control electrical circuitry 118.

The one or more dispense elements 114 can be coupled to at least one material reservoir 126. The at least one material reservoir 126 can be configured to store the one or more materials that are used to print an object on the region of interest 104. The at least one material reservoir 126 can be located in the one or more dispense elements 114 or located remotely from the one or more dispense element 114. For example, the at least one material reservoir 126 can be at least partially enclosed by the printing head 112. The at least one material reservoir 126 can be coupled to the one or more dispense elements 114 using one or more conduits 120.

The at least one material reservoir 126 can store any of a variety of or combinations of materials. The at least one material reservoir 126 can store natural materials or synthetic materials. The at least one material reservoir 126 can store non-organic materials, such as metallic materials, ceramic materials, polymeric materials, other non-organic materials. The at least one material reservoir 126 can store materials for use in forming biocompatible structures, microstructures, nanostructures, scaffolds, nanoscaffolds, or the like. For example, such materials include natural or synthetic polymers, polymer fibers, microfibers, nanofibers, hydrogels, thermo-responsive polymers, Matrigel™ or the like. Non-limiting examples of materials used as scaffolds in tissue engineering are described by Bajaj et al., in Annu Rev Biomed Eng. 2014 Jul. 11; 16: 247-276 (3D Biofabrication Strategies for Tissue Engineering and Regenerative Medicine), which is incorporated herein, in its entirety, by this reference. The at least one material reservoir 126 can store organic or biological materials, such as bioinks, cells, transfected cells, cell products, peptides, proteins, carbohydrates, lipids or tissue. The biological materials can include a biomimetic. The at least one material reservoir 126 can store materials including encapsulation materials in which materials are encapsulated, such as natural or synthetic polymers, phase change polymers, polymersomes, liposomes, or the like. The encapsulating materials can include materials stored or encapsulated therein, such as organic or nonorganic materials, compounds (e.g. medicament), or any biological material.

The biological materials used herein can include materials used to form implants, grafts, or tissues (e.g., vascularized or micro-vasculature tissue). For example, the biological material can include one or more cells including, but are not limited to, stem cells, meschenchymal cells, fibroblasts, adipocytes, pre-adipocytes, hepatocytes, osteocytes, myocytes, cardiomyocytes, smooth muscle cells, endothelial cells, epithelial cells, keratinocytes, primary cells, cultured cells, or the like. For example, the biological material can include one or more proteins including, but are not limited to, collagen, elastin, hyaluronan, fibrin, or laminin; a growth-promoting agent or any growth factor; a cytokine or chemokine; or any immune-related protein. For example, the biological material can include one or more lipids including a phospholipid, sphingolipid, or proteolipid. For example, the biological material can include one or more carbohydrates including any oligosaccharide. The one or more carbohydrates can be associated with one or more peptides, one or more proteins or one or more lipids, such as a proteoglycan, glycoprotein, glycosaminoglycan, glycolipid, or the like. For example, the one or more biomaterials can alone or together arise from, include, or form part or all of an extracellular matrix. For example, the one or more biomaterials can include a tissue, such as a tissue sphere or tissue strand, which can be included in a bioink. The at least one material reservoir 126 can store one or more support materials that facilitate printing the one or more materials onto the region of interest 104. When the one or more materials are biological, the one or more support materials can include an inflammatory suppressant, substances that facilitate the regrowth of tissues (e.g., neurotrophin, adenosine triphosphate, vascular endothelial growth factor, or other growth factors), pain suppressant, suppressors of autoimmune factors, tissue survival promoters (e.g., anti-beta amyloid antibodies when printing neural tissue), or other similar materials. In an embodiment, the one or more support materials can include a binder, a material that supports portions of the printed object and can be removed from the object (e.g., a polymer that is burned off or vaporizes while the object densifies), an emulsifier, or a coating. For example, the at least one material reservoir 126 can store one or more materials used to form capillaries and vascular endothelial growth factor.

Further examples of a printing device including one or more elongated members and one or more dispense elements coupled to the one or more elongated members are disclosed in U.S. patent application Ser. No. 14/664,405 filed on 20 Mar. 2015, the disclosure of which was previously incorporated herein.

The printing system 100 can further include one or more sensors 128 configured to detect at least one characteristic of the region of interest 104 or the printing system 100. The at least one characteristic of the region of interest 104 sensed by the one or more sensors 128 can include pressure, temperature, hydration, chemistry, surface contour, boundary conditions, or other features of the region of interest 104. The at least one characteristic of the printing system 100 that can be sensed by the one or more sensors 128 can include the position of a component of the printing system 100, such as a position or movement of the one or more flushing elements 102; the flow of the one or more flushing agents, the flow of one or more materials, temperature of the printing system 100, flushing agent to be dispensed or that has been dispensed, or material to be dispensed or that has been dispensed; or other characteristics of the printing system 100. As such, the one or more sensors 128 can include a temperature sensor configured to sense temperature of the region of interest 104, a pressure sensor configured to sense pressure of the region of interest 104, a hydration sensor configured to sense moisture of the region of interest 104, a chemical sensor configured to sense one or more chemical elements or molecules on, in, or near the region of interest 104 (e.g., an oxygen sensor), a biosensor configured to sense biological matter of the region of interest 104, an optical sensor, an infrared sensor, other electromagnetic sensors (e.g., radar), a position sensor configured to sense position of the one or more flushing elements 102, the printing head 112, or the printing device; an accelerometer configured to sense acceleration of the one or more flushing elements 102, the printing head 112, or the printing device; a flow gauge configured to sense flow of the one or more flushing agents or one or more materials dispensed from the one or more flushing elements 102 or the printing device, respectively; a depth sensor (e.g., depth gauge) configured to sense depth of the region of interest 104 in a subject, an acoustic sensor configured to sense amount or volume of the one or more flushing agents or the one or more materials dispensed onto the region of interest 104, a tilt sensor configured to sense tilting of the printing head 112, or other suitable sensors. Some sensors can require a stimulus source that emits a stimulus the sensor detects. For example, a chemical sensor mounted to a printing system 100 can include a light source that scatters or excites chemical elements or molecules present on or near the region of interest 104 to identify the chemical elements or molecules via spectroscopy.

In an embodiment, the one or more sensors 128 can be communicably coupled to the controller 116. The controller 116 can communicate a direction directly or indirectly to at least one sensor 128 to detect a characteristic. Alternatively, the at least one sensor 128 can automatically detect the characteristic without receiving the direction. The at least one sensor 128 can detect the characteristic and send information related to the detected characteristic to the controller 116. The controller 116 can use the information to operate at least a portion of the printing system 100. For example, the controller 116 can request the one or more sensors 128 to detect the position and relative movement of the one or more elongated members 110 using a position sensor and an accelerometer. The control electrical circuitry 118 can use the detected information from the one or more sensors 128 to controllably steer or calibrate the one or more actuators of the one or more elongated members 110 and dispensing of the one or more flushing agents from the one or more flushing elements 102.

In an embodiment, each of the one or more sensors 128 can communicate with each other, including communicating information detected. The sensing by the one or more sensors 128 can occur responsive to the information received from the other sensors 128 or responsive to direction from the control electrical circuitry 118. In an embodiment, the one or more sensors 128 can be attached to different components of the printing system 100. For instance, a sensor 128 can be positioned on the printing head 112, the one or more elongated members 110, the one or more flushing elements 102, or the printing device. The location of the one or more sensors 128 can be configured to not substantially interfere with or influence the operation of the one or more flushing elements 102, the one or more elongated members 110, or the printing device.

The controller 116 can be communicably coupled, either directly or indirectly, to at least one of the printing head 112, the support structure 122, the one or more elongated members 110, the one or more flushing elements 102, the at least one flushing agent reservoir 108, and the printing device (e.g., the one or more elongated members 110, the one or more dispense elements 114, and the at least one material reservoir 126). For example, FIG. 1 illustrates that the controller 116 is communicably coupled directly to the printing head 112. The controller 116 can then be communicably coupled indirectly to other components of the printing system 100 through the printing head 112. The controller 116 can be communicably coupled through a wired or wireless (e.g., Bluetooth, Wi-Fi) connection. The controller 116 can be remote from at least one the printing head 112, the one or more elongated members 110, the one or more flushing elements 102, or the printing device. In an embodiment, the controller 116 can be at least partially positioned within the printing head 112, the one or more elongated members 110, or the one or more flushing elements 102.

The controller 116 can include a user interface 130 that enables an individual to communicate with the printing system 100. The user interface 130 can include a display, mouse, keyboard, microphone, speaker, or any other device that enables an individual to communicate with the printing system 100. The user interface 130 can also include software that enables the user to communicate with the printing system 100 such as an operating system, operator controls or a process control. In an embodiment, the user interface 130 can enable an individual to input instructions or commands into the printing system 100. The commands can include instructions to prepare the region of interest 104, information about the one or more flushing agents, build data (e.g., a CAD file), information about the one or more flushing agents, information about one or more components of the printing system 100, instructions to execute a program, instructions to cancel an operation, etc. In an embodiment, the printing system 100 can be configured to receive and accept the instructions or commands inputted into the user interface 130. In an embodiment, the printing system 100 can send data to the user interface 130. The data can include information about the current status of the operation to prepare the region of interest 104, the current status of the printing operation, the current status of the printing system 100, an error, or additional information. The user interface 130 can display the data.

The controller 116 can further include memory 132 storing operational instructions for operating the printing system 100. The memory 132 can include random access memory (RAM), read only memory (ROM), a hard drive, a disc (e.g., blue-ray, DVD, or compact disc), flash memory, other types of memory electrical circuitry, or other suitable memory. The instructions stored on the memory 132 can include a CAD file, a program configured to operate the printing system 100, information about the printing system 100 and the components thereof, information gathered by the printing system 100, or additional information. The controller 116 can further include a processor 134 configured to direct certain operations of the printing system 100 according to the instructions contained in the memory.

As previously discussed, the controller 116 includes the control electrical circuitry 118. In an embodiment, the control electrical circuitry 118 controls one or more components of the printing system 100 responsive to programming and instructions stored on the memory 132 or received from the user interface 130. In an embodiment, the control electrical circuitry 118 controls one or more components of the printing system 100 responsive to direction from one or more components of the controller 116 (e.g., processor 134). In an embodiment, the control electronic circuitry 118 controls one or more components of the printing system 100 responsive to instructions or programming contained within the control electronic circuitry 118. The control electrical circuitry 118 can be integrally formed with the memory 132 and the processor 134 of the controller 116. Alternatively, the control electrical circuitry 118 can be separate from the memory 132 and the processor 134 of the controller 116. In such an embodiment, the control electrical circuitry 118 can include its own memory and a processor.

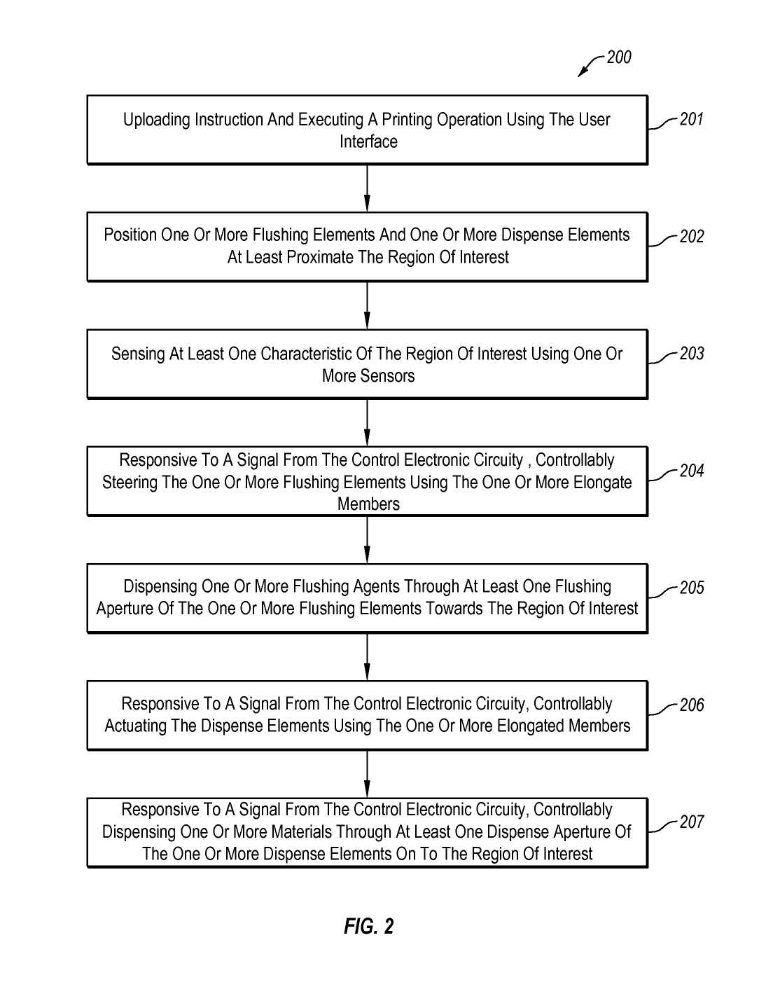

FIG. 2 is a flow diagram 200 of a method of using the printing system 100 of FIG. 1 according to an embodiment. In act 201, a user can upload instructions and execute a printing operation using the user interface 130. For example, the user can load instructions into the memory 132 for preparing the region of interest 104 to have an object printed thereon. The user can also load, for example, a CAD file of the object to be printed on the region of interest 104. The instructions can be stored in the memory 132. Additionally, the user can instruct to printing system 100 to execute a printing operation. The printing operation can include at least preparing the region of interest 104 to have the object printed thereon. Upon receiving the instructions from the user interface 130, the control electrical circuitry 118 can communicate directions to the different components of the printing system 100.

In act 202, the printing system 100 can position the one or more flushing elements 102 and the one or more dispense elements 114 at least proximate to the region of interest 104. In an embodiment, the printing system 100 (e.g., a portable printing system 100) can be positioned near the region of interest 104 and the printing system 100 can position the one or more flushing elements 102 or the one or more dispense elements 114 are proximate the region of interest 104. In an embodiment, the printing system 100 can move the printing head 112 to the second position.

In act 203, the printing system 100 can sense at least one characteristic of the region of interest 104 using one or more sensors 128. For example, the one or more sensors 128 can include at least one position sensor configured to detect the portion of the one or more flushing elements 102 relative to the region of interest 104. In another example, the one or more sensors 128 can include at least one flow gauge configured to detect the flow of the one or more flushing agents from the one or more flushing elements 102. In an embodiment, the one or more sensors 128 can transmit the detected characteristics of the region of interest 104 to the controller 116.

In act 204, responsive to a signal from the control electrical circuitry 118, the printing system 100 can controllably steer the one or more flushing elements 102 using the one or more elongated members 110. For example, the one or more elongated members 110 can position the one or more flushing elements 102 adjacent to or proximate to a specific segment of the region of interest 104 responsive to the signal or direction from the control electrical circuitry 118. In act 205, the printing system 100 can dispense one or more flushing agents through at least one flushing aperture 106 of the one or more flushing elements 102 towards the region of interest 104. For example, the control electrical circuitry 118 can communicate a direction instructing at least one of the one or more flushing elements 102, the at least one flushing agent reservoir 108, or the one or more conduits 120 to dispense the one or more flushing agents. The control electrical circuitry 118 can communicate a direction to disperse the one or more flushing agents towards the specific segment of the region of interest 104. For example, the direction to disperse the one or more flushing agents can cause one or more valves to partially open or a pressure to be applied to the one or more flushing agents.

In act 206, responsive to a signal from the control electronic circuitry, the printing system 100 can controllably actuate the dispense elements 114 using the one or more elongated members 110. The one or more elongated members 110 can position the one or more dispense elements 114 adjacent to or proximate to a specific segment of the region of interest 104. In act 207, responsive to a signal from the control electronic circuitry, the printing system 100 can controllably dispense one or more materials through at least one dispense aperture 324 of the one or more dispense elements 114 onto the region of interest 104. For example, the control electrical circuitry 118 can communicate the signal or direction instructing at least one of the one or more dispense elements 114, the at least one material reservoir 126, or the one or more conduits 120 to dispense the one or more materials. The control electrical circuitry 118 can communicate a direction to disperse the one or more materials onto the specific segment of the region of interest 104. This method can be repeated until the three-dimensional object is partially or completely printed, as desired.

In an embodiment, the one or more flushing elements 102 can dispense the one or more flushing agents towards the region of interest 104 after the object is completely printed on the region of interest 104. In an embodiment, the one or more flushing elements 102 can dispense one or more flushing agents to remove contaminants present on the object after printing. In an embodiment, the one or more flushing elements 102 can dispense one or more corrosive agents onto the object after printing. For example, it can be beneficial to form an oxide layer on at least one surface of the object. In another example, the one or more corrosive agents can remove material from the object, such as a support material, that is no longer needed.

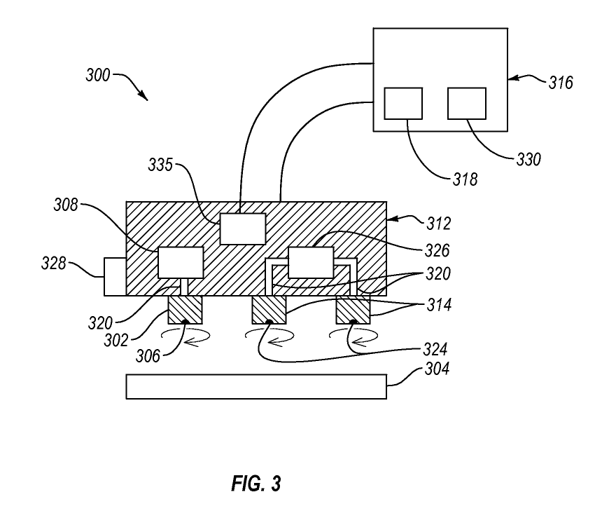

FIG. 3 is a schematic cross-sectional view of a printing system 300 according to an embodiment. The printing system 300 can include one or more flushing elements 302. The one or more flushing elements 302 can be similar to the flushing elements 102 illustrated in FIG. 1. For example, each of the one or more flushing elements 302 can include at least one flushing aperture 306 configured to dispense one or more flushing agents towards the region of interest 304. The one or more flushing elements 302 are coupled to at least one flushing agent reservoir 308 via one or more conduits 320. The printing system 300 can further include a printing head 312. The printing system 300 can also include any of the printing devices disclosed herein. For example, the printing device can include one or more dispense elements 314 including one or more dispense apertures 324. The one or more dispense elements 314 can be coupled to at least one material reservoir 326 via one or more conduits 320. The printing system 300 further includes a controller 318 that includes control electrical circuitry 318 and a user interface 330. The control electrical circuitry 318 can direct the operation of the components of the printing system 300 after a user inputs instructions or commands into the user interface 330.

In an embodiment, the one or more flushing elements 302 or one or more dispense elements 314 can be coupled to and supported by the printing head 312. For example, the one or more flushing elements 302 or the one or more dispense elements 314 can be rigidly or semi-rigidly coupled to the printing head 312. In an embodiment, the one or more flushing elements 302 or the one or more dispense elements 314 can rotate or tilt relative to the printing head 312. For example, the one or more flushing elements 302 or the one or more dispense elements 314 can include a first portion that is fixed to the printing head 312 and a second portion that rotates relative the printing head 312. The first portion can be rigidly or semi-rigidly attached to the printing head 312. The one or more flushing elements 302 or the one or more dispense elements 314 can include a motor 335 or other actuator that rotates the second portion. For example, the motor 335 can rotate the second portion of the one or more flushing elements 302 or the one or more dispense elements 314 responsive to direction from the control electrical circuitry 318. In the illustrated embodiment, the motor 335 may be indirectly or directly communicably coupled to the control electrical circuitry 318.

The one or more flushing elements 302 or the one or more dispense elements 314 coupled to the printing head 312 can be used in any of the printing systems disclosed herein. For example, any of the printing systems disclosed herein can include one or more flushing elements 302 that are coupled to and rotate relative to the printing head 312.

The printing system 300 can further include one or more sensors 328 configured to detect at least one characteristic of the region of interest 304 or the printing system 300. The one or more sensors 328 can be substantially similar to the one or more sensors 128 shown in FIG. 1. For example, the one or more sensors 328 can detect the relative rotation of the second portion of the one or more flushing elements 302 relative the printing head 312. The one or more sensors 328 can transmit the detected characteristics to a controller 316. The controller 316 can include a user interface 330 and control electrical circuitry 318.

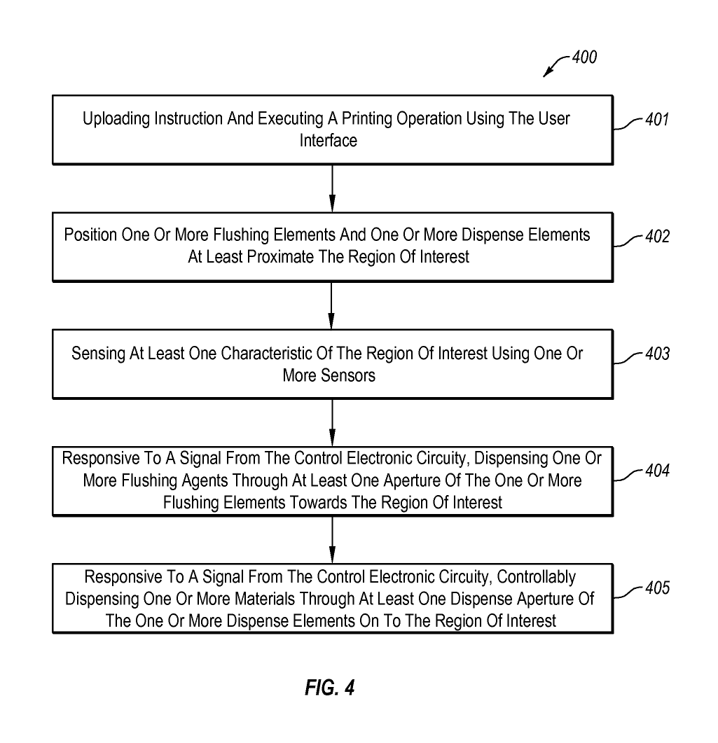

FIG. 4 is a flow diagram 400 of a method of using the printing system 300 shown in FIG. 1 according to an embodiment. In act 401, the user can upload instructions and execute a printing operation using the user interface 330. The instruction can include instructions to prepare the region of interest 304 to have an object printed thereon. The user can also execute a printing operation using the user interface 330. Upon executing the printing operation, the control electrical circuitry 318 can direct one or more components of the printing system 300.

In act 402, the printing system 300 can position one or more flushing elements 302 and one or more dispense elements 314 at least proximate the region of interest 304. In act 403, the printing system 300 senses at least one characteristic of the region of interest 304 using one or more sensors 328. In act 404, responsive to a signal from the control electronic circuitry 318, the printing system can dispense one or more flushing agents through at least one aperture 306 of the one or more flushing elements 302 towards the region of interest 304. In an embodiment, the one or more flushing elements 302 can rotate or tilt while dispensing the one or more flushing agents. For example, the control electronic circuitry 318 can direct the motor 335 to rotate or tilt the one or more flushing elements 302 while dispensing the one or more flushing agents. In act 405, responsive to a signal from the control electric circuitry 318, the printing system 300 can controllably dispense one or more materials through at least one dispense aperture 324 of the one or more dispense elements 314 onto the region of interest 304. In an embodiment, the one or more dispense elements 314 can rotate or tilt while dispensing the one or more materials. For example, the control electronic circuitry 318 can direct a motor 335 to rotate or tilt the one or more dispense elements 314 while dispensing the one or more materials.

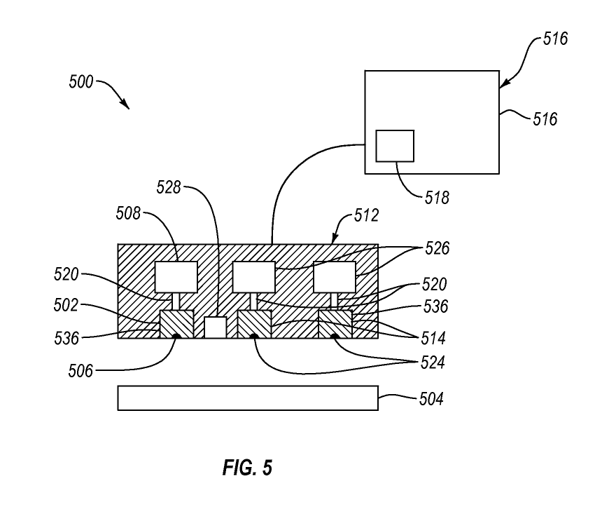

FIG. 5 is a schematic cross-sectional view of a printing system 500 according to an embodiment. The printing system 500 can be substantially similar to the printing system 300 illustrated in FIG. 3. However, the printing system 500 can include a printing head 512 that has one or more flushing elements 502 at least partially enclosed in or incorporated into the printing head 512. Similarly, the one or more dispense elements 514 can be at least partially enclosed in or incorporated into the printing head 512. The printing head 512 that at least partially encloses or incorporates the one or more flushing elements 502 or the one or more dispense elements 514 can be used in any of the printing systems disclosed herein. Additionally, the printing system 500 can also include one or more sensors 528 at least partially enclosed by or incorporated into the printing head 512. In an embodiment, the one or more flushing elements 502 or the one or more dispense elements 514 may controllably dispense one or more flushing agents or one or more materials, respective, responsive to direction from the control electrical circuitry 518 of the controller 516.

In an embodiment, the printing head 512 can at least partially enclose the one or more flushing elements 502 or the one or more dispense elements 514. The printing head 512 can include one or more recesses 536 formed therein that at least partially receive the one or more flushing elements 502 or the one or more dispense elements 514. The one or more flushing elements 502 or the one or more dispense elements 514 can be secured in the one or more recesses 536 using an adhesive, a threaded attachment, or another suitable attachment technique. When inserted into the one or more recesses 536, the one or more flushing elements 502 or the one or more dispense elements 514 can be coupled to the at least one flushing agent reservoir 508 or the at least one material reservoir 526, respectively, via one or more conduits 520.

In an embodiment, the printing head 512 can incorporate the one or more flushing elements 502 or the one or more dispense elements 514 therein. For example, the printing head 512 can include at least one flushing aperture 506 or at least one dispense aperture 524 formed therein. The at least one flushing aperture 506 can be coupled to one or more flushing agents reservoirs 508 and the at least one dispense aperture 524 can be coupled to the at least one material reservoir 526 via one or more conduits 520. The printing head 512 can further include any of the components discussed herein that can be used by the one or more flushing elements or the one or more dispense elements. For example, the printing head 512 can include a heat source. Similarly, the printing head 512 can include a device that dispenses the one or more flushing agents or the one or more dispense agents, such as a pump or compressor.

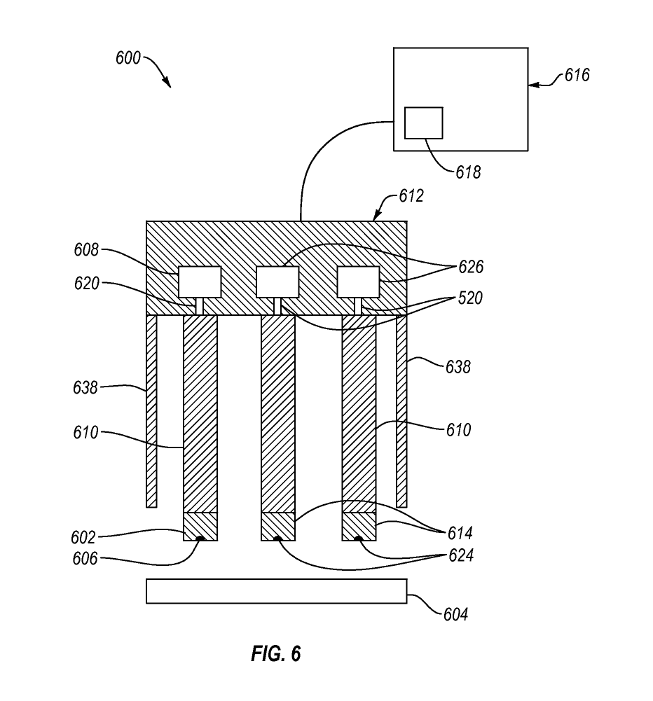

FIG. 6 is a schematic cross-sectional view of a printing system 600 configured to be inserted into an internal region of a body of a subject (e.g. during laparoscopic surgery), according to an embodiment. The printing system 600 can utilize any of the printing system embodiments illustrated and described in connection with the printing systems shown in FIGS. 1, 3, 5, and 7.

In the illustrated embodiment, the printing system 600 is substantially similar to the printing system 100 shown in FIG. 1. For example, the printing system 600 includes one or more flushing elements 602 coupled to one or more elongated members 610. The one or more flushing elements 602 can be also coupled to at least one flushing agent reservoir 608 via one or more conduits 620. The printing system 600 also includes a printing device including one or more dispense elements 614. The one or more dispense elements 614 can be coupled to one or more elongated members 610 and include at least one dispense aperture 624. The one or more dispense elements 614 can be coupled to at least one material reservoir 626 via one or more conduits 620. The one or more elongated members 610 can be coupled to and support by the printing head 612. The one or more elongated members 610 can be controllably steered responsive to direction from the control electrical circuitry 618 of the controller 616. The one or more flushing element 602 and the one or more dispense elements 614 can also controllably dispense the one or more flushing agents and the one or more materials, respectively, responsive to direction from the control electrical circuitry 618.

Referring to FIG. 6, the printing system 600 can be configured to be partially inserted into an internal region of interest 604 of a living subject (e.g. an animal, a person). The internal region of interest 604 of a living subject can include any region that is integral to a biological body. For example, the internal region of interest 604 of a human body can include a region that is epidermal, endodermal, subdermal, subcutaneous, intraperitoneal, intra-abdominal, intra-organ, intracranial, skeletal, muscular, nervous, cardiac, luminal, endoluminal, etc. In such an embodiment, the printing head 612 can remain outside the subject while the one or more elongated members 610 can be configured to be inserted into the internal region of interest 604 (e.g., an epidermal region, an endodermal region, a subdermal region, a subcutaneous region, an intraperitoneal region, an intra-abdominal region, an intra-organ region, an intracranial region, a skeletal region, a muscular region, a nervous region, a cardiac region, a visceral region, a parietal region, a lumenal region, an endolumenal region, etc.). For example, during laparoscopic surgery, the printing head 612 can be positioned adjacent to an opening of a trocar or a cannula. The trocar or cannula can be partially inserted into the living subject. The one or more elongated members 610 can be inserted into the subject using the trocar or cannula.

The printing system 600 can include a body-insertable device 638 configured to insert the one or more elongated members 610, the one or more flushing elements 602, and the one or more dispense elements 614 into the subject and access the internal region of interest 604. In an embodiment, the body-insertable device 638 can include a catheter, endoscope, or other suitable device. For example, the body-insertable device 638 can include an endoscope that includes at least one channel configured to house the one or more elongated members 610, the one or more flushing elements 602, or the one or more dispense elements 614. The body-insertable device 638 can be configured to protect or guide the one or more elongated members 610, the one or more flushing elements 602, or the one or more dispense elements 614, while the one or more elongated members 610, the one or more flushing elements 602, or the one or more dispense elements 614 are inserted into the subject. The body-insertable device 638 can also support the one or more elongated members 610 during the printing process. As such, the body-insertable device 638 can at least partially house the one or more elongated members 610, the one or more flushing elements, or the one or more dispense elements 614. For example, portions of the one or more elongated members 610, the one or more flushing elements 602, or the one or more dispense elements 614 can protrude from the body-insertable device 638. Alternatively, the one or more elongated members 610, the one or more flushing elements 602, or the one or more dispense elements 614 can be configured to be completely housed in the body-insertable device 638 while being inserted into the subject. However, when the body-insertable device 638 is proximate to the internal region of interest 604, the one or more elongated members 610 can actuate such that portions of the one or more elongated members 610, the one or more flushing elements 602, or the one or more dispense elements 614 protrude from the body-insertable device 638. In an embodiment, the body-insertable device 638 can be attached to the printing head 612. Alternatively, the body-insertable device 638 can only house a portion of the one or more elongated members 610, the one or more flushing elements 602, or the one or more dispense elements 614.

In an embodiment, the printing system 600 can be configured to operate during laparoscopic surgery. For example, the body-insertable device 638 can at least partially house the one or more elongated members 610, the one or more flushing elements 602, or the one or more dispense elements 614. In such an embodiment, a trocar can be inserted into the subject and the body-insertable device 638 can be inserted into a subject via the trocar. An individual operating the printing system 600 can guide the body-insertable device 638 using one or more sensors 628 attached to the body-insertable device 638, the one or more elongated members 610, the one or more flushing elements 602, or the one or more dispense elements 614. The one or more sensors 628 can include a video camera with a cold light source (e.g., halogen or xenon). When the body-insertable device 638 reaches the internal region of interest 604, the control electrical circuitry 618 can steer the one or more elongated members 610, thereby controllably steering the one or more flushing elements 602 or the one or more dispense elements 614. In an embodiment, the one or more flushing elements 602 can dispense one or more flushing agents stored in the at least one flushing agent reservoir 608 through at least one flushing aperture 606, thereby preparing the internal region of interest 604 to have an object printed thereon by the one or more dispense elements 614.

In an embodiment, the printing system 600 can be used during the laparoscopic surgery. For example, the one or more flushing elements 602 can prepare the internal region of interest 604 to have an object printed thereon. The one or more flushing elements 602 can prepare the internal region of interest 604 by dispensing one or more cleaning agents onto the internal region of interest 604 to remove one or more substances therefrom. Similarly, the one or more flushing elements 602 can dispense one or more sterilizing agents or one or more antimicrobial agents. After the laparoscopic surgery is complete, the printing system 600 can be used to speed the healing process. For example, the one or more dispense elements 614 of the printing system 600 can controllably dispense biological materials into the subject such as tissue, grafts, or cells, such as printing tissue, capillaries, or similar structures within the body. Such printing operations can use the one or more flushing elements 602 to dispense one or more flushing agents to prepare the body to receive the tissue, grafts, or cells. In an embodiment, the printing system 600 can only be configured to be used during or after the laparoscopic surgery.

In an embodiment, the printing system 600 can be configured to be substantially inserted into the subject. For example, the printing system 600 can include a body-insertable device 638 that can be configured to at least partially house the printing head 612 along with the one or more elongated members 610, the one or more flushing elements 602, or the one or more dispense elements 614. As such, the printing head 612 can be inserted into the subject along with the one or more elongated members 610, the one or more flushing elements 602, or the one or more dispense elements 614. However, the printing system 600 can be configured to be inserted into the subject without the use of the body-insertable device 638.

In the illustrated embodiment, the controller 616 is illustrated to be remote from the printing head 612 and configured to not be inserted into the subject. However, in other embodiments, the controller 616 can be configured to be inserted subcutaneously. For example, at least a portion of the controller 616 can be positioned within the printing head 612.

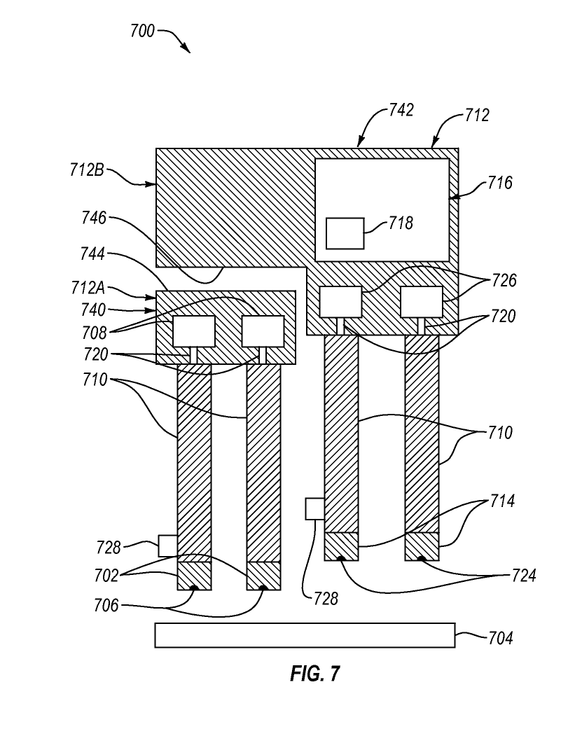

FIG. 7 is schematic cross-sectional view of a printing system 700 that includes at least one reversibly attachable cartridge 740, according to an embodiment. The printing system 700 can be substantially similar to any of the printing systems disclosed herein except that the printing system 700 includes a reversibly attachable cartridge 740. It should be noted that the reversibly attachable cartridge 740 can be used in any of the printing systems disclosed herein.

In an embodiment, the printing system 700 can be similar to the printing system 100 shown in FIG. 1. For example, the printing system 700 can include one or more flushing elements 702 that dispense one or more flushing agents towards a region of interest 704. The one or more flushing elements 702 can be coupled to one or more elongated members 710 and include at least one flushing aperture 706. The one or more flushing elements 702 can be coupled to at least one flushing agent reservoir 708 via one or more conduits 720. The printing system 700 can further include a printing device that includes one or more dispense elements 714 configured to dispense one or more materials onto the region of interest 704. For example, the one or more dispense elements 714 can be coupled to one or more elongated members 710 and include at least one dispense aperture 724. The one or more dispense elements 714 can be coupled to at least one material reservoir 726 using one or more conduits 720. The one or more elongated members 710 can controllably steer the one or more flushing elements 702 or the one or more dispense elements 714. The one or more elongated members 710 can be coupled to and extend from a printing head 712. The printing system 700 can further include one or more sensors 728 configured to sense one or more characteristics of the region of interest 704. The printing system 700 also includes a controller 716 at least partially enclosed in or incorporated into the printing head 712. The controller 716 can include control electrical circuitry 718.

The printing system 700 further includes a reversibly attachable cartridge 740. The reversibly attachable cartridge 740 is a portion of the printing system 700 that is configured to be reversibly attached to another portion 742 of the printing system 700. In an embodiment, the reversibly attachable cartridge 740 can include at least one component of the printing system 700. For example, the reversibly attachable cartridge 740 can include at least one of the one or more flushing elements 702, the one or more dispense elements 714, the one or more elongated members 710, the at least one flushing agent reservoir 708, the at least one material reservoir 726, the one or more sensors 728, the printing head 712, the controller 716, or other components of the printing system 700. In an embodiment, the reversibly attachable cartridge 740 can include just a single flushing element 702. In an embodiment, the reversibly attachable cartridge 740 can include the printing head 712 and every component coupled thereto (e.g., the another portion 742 of the printing system 700 includes the support structure, not shown). In an embodiment, the reversibly attachable cartridge 740 can include the printing device. In such an embodiment, the reversibly attachable cartridge 740 enables the another portion 742 to be used with any known printing device. In an embodiment, the reversibly attachable cartridge 740 can include just a portion of a single component of the printing system 700. For example, the cartridge can include a disk including a hole therein configured to be reversibly attached to the rest of a flushing element 702. In an embodiment, the printing system 700 can include a plurality of reversibly attachable cartridges 740. The plurality of reversibly attachable cartridges 740 can be reversibly attached to each other. For example, the printing system 700 can be completely formed of a plurality of reversibly attachable cartridges 740.

The reversibly attachable cartridge 740, the another portion 742 of the printing system 700, or both can include means to reversibly attach the reversibly attachable cartridge 740. Means to reversibly attach include any method of attachment that enables the reversibly attachable cartridge 740 to attach to and to be detached from the another portion 742 of the printing system 700 without substantially damaging either the reversibly attachable cartridge 740 or the another portion 742 of the printing system 700. The means to reversibly attach the reversibly attachable cartridge 740 to the another portion 742 can include an adhesive, one or more threaded fasteners (e.g., one or more screws), a threaded connection, an adapter, a barbed connection, a luer lock, one or more magnets, a clamp, a snap fit, or a pin.

The reversibly attachable cartridge 740, the another portion 742 of the printing system 700, or both can also include one or more features configured to position or support the reversibly attachable cartridge 740 against the another portion 742 of the printing system 700. For example, at least one of the reversibly attachable cartridge 740 or the another portion 742 of the printing system 700 can include a recess, ridge, groove, raised feature, surface shape, surface topography, or other feature that positions or supports the reversibly attachable cartridge 740 against the another portion 742 of the printing system 700.

The reversibly attachable cartridge 740 can include housing configured to support the one or more components of the reversibly attachable cartridge 740. For example, the housing can include a portion of the printing head 712. In another example, the housing can include a rigid or semi-rigid material between one or more components of the reversibly attachable cartridge 740. The rigid or semi-rigid material may be broken after the reversibly attachable cartridge 740 is attached to the another portion 742 of the printing system 700 and before the printing system 700 is used.

Referring to FIG. 7, the reversibly attachable cartridge 740 can include one or more flushing elements 702 coupled to one or more elongated members 710. The one or more flushing elements 702 can also be coupled to at least one flushing agent reservoir 708 via one or more conduits 720. The reversibly attachable cartridge 740 can also include a housing configured to support the one or more components of the reversibly attachable cartridge 740. In an embodiment, the printing system 700 may include a printing head 712 having a first portion of the printing head 712A and a second portion of the printing head 712B. The housing may include the first portion of the printing head 712A. The first portion of the printing head 712A can include the one or more elongated members 710 coupled thereto and extending therefrom. Also, the first portion of the printing head 712A can include the at least one flushing agent reservoir 708 and one or more conduits 720 therein. The reversibly attachable cartridge 740 can further include one or more sensors 728 configured as any of the sensors disclosed herein.

The another portion 742 of the printing system 700 can receive the reversibly attachable cartridge 740. In an embodiment, the another portion 742 of the printing system 700 includes a second portion of the printing head 712B. The second portion of the printing head 712B can support the components of the another portion 742 of the printing system 700. The second portion of the printing head 712B can be configured to receive the first portion of the printing head 712A. For example, in the illustrated embodiment, the second portion of the printing head 712B includes a generally rectangular cutout configured to receive the first portion of the printing head 712A.

The first portion of the printing head 712A and the second portion of the printing head 712B can include can include a first surface 744 and second surface 746, respectively. In an embodiment, at least one of the first surface 744 or the second surface 746 can include means to reversibly attach the reversibly attachable cartridge 740 to the another portion of the printing system 700. For example, at least one of the first surface 744 or the second surface 746 can include an adhesive thereon. In an embodiment, the first surface 744 can include one or more recesses configured to mate with one or more raised features on the second surface 746. The one or more recesses and the one or more raised features can be used to position, support, or attach the reversibly attachable cartridge 740 to the another portion 742 of the printing system 700. In an embodiment, the first portion of the printing head 712A or the second portion of the printing head 712B can include an attachment means therein. For example, the first portion of the printing head 712B can include a magnet therein. The another portion 742 of the printing system 700 can include a ferromagnetic material (e.g., the second surface 746) or a magnet therein oriented to attach first portion of the printing head 712A to the second portion of the printing head 712B.

The reversibly attachable cartridge 740 can enable the printing system 700 to be modified to perform different printing operations. In an embodiment, the printing system 700 can be initially configured to print in a biological environment. However, the printing system 700 can be modified to operate in an oxidizing environment. For example, components of the printing system 700 formed of a biocompatible materials can be replaced with components formed of oxidation resistant materials, if necessary. Also, the at least one flushing agent reservoir 708 or the at least one material reservoir 726 can be replaced with different flushing agents or materials, if needed. In an embodiment, the reversibly attachable cartridge 740 can include different types of printing devices. Switching between the different types of printing devices enables the printing system 700 to a printing device that is best suited for the printing operation. As such, multiple printing operations can be performed by a single printing system 700.

Similarly, the reversibly attachable cartridge 740 can enable the printing system 700 to replace spent or damaged components. In an embodiment, the reversibly attachable cartridge 740 can enable a flushing agent reservoir 708 to be replaced when the flushing agent reservoir 708 is spent. In an embodiment, the one or more elongated members 710 can include a shape memory material actuator. After a plurality of actuations, the shape memory material actuator can experience “amnesia,” that is, deform differently (e.g., less) than the original shape memory material actuator when exposed to a temperature. As such, the reversibly attachable cartridge 740 can enable the replacement of the shape memory material actuator.

In an embodiment, the reversibly attachable cartridge 740 can even be adapted for use with a printing system that the reversibly attachable cartridge 740 was not specifically configured to be used with. For example, the reversibly attachable cartridge 740 can be modified to be operably coupled to a controller of an existing printing system when the reversibly attachable cartridge 740 is computer controlled so that the reversibly attachable cartridge 740 is controlled by such a controller. In other embodiments, the reversibly attachable cartridge 740 can be manually operated in conjunction with an existing printing system that it was not specifically configured to be used with in order to prepare a region of interest for printing.

The reader will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. The reader will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer can opt for a mainly hardware and/or firmware vehicle; alternatively, if flexibility is paramount, the implementer can opt for a mainly software implementation; or, yet again alternatively, the implementer can opt for some combination of hardware, software, and/or firmware. Hence, there are several possible vehicles by which the processes and/or devices and/or other technologies described herein can be effected, none of which is inherently superior to the other in that any vehicle to be utilized is a choice dependent upon the context in which the vehicle will be deployed and the specific concerns (e.g., speed, flexibility, or predictability) of the implementer, any of which can vary. The reader will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In an embodiment, several portions of the subject matter described herein can be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, the various embodiments described herein can be implemented, individually and/or collectively, by various types of electro-mechanical systems having a wide range of electrical components such as hardware, software, firmware, or virtually any combination thereof; and a wide range of components that can impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electrical systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context can dictate otherwise.

In a general sense, the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). The subject matter described herein can be implemented in an analog or digital fashion or some combination thereof.

This disclosure has been made with reference to various example embodiments. However, those skilled in the art will recognize that changes and modifications can be made to the embodiments without departing from the scope of the present disclosure. For example, various operational steps, as well as components for carrying out operational steps, can be implemented in alternate ways depending upon the particular application or in consideration of any number of cost functions associated with the operation of the system; e.g., one or more of the steps can be deleted, modified, or combined with other steps.

Additionally, as will be appreciated by one of ordinary skill in the art, principles of the present disclosure, including components, can be reflected in a computer program product on a computer-readable storage medium having computer-readable program code means embodied in the storage medium. Any tangible, non-transitory computer-readable storage medium can be utilized, including magnetic storage devices (hard disks, floppy disks, and the like), optical storage devices (CD-ROMs, DVDs, Blu-ray discs, and the like), flash memory, and/or the like. These computer program instructions can be loaded onto a general purpose computer, special purpose computer, or other programmable data processing apparatus to produce a machine, such that the instructions that execute on the computer or other programmable data processing apparatus create a means for implementing the functions specified. These computer program instructions can also be stored in a computer-readable memory that can direct a computer or other programmable data processing apparatus to function in a particular manner, such that the instructions stored in the computer-readable memory produce an article of manufacture, including implementing means that implement the function specified. The computer program instructions can also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

In an embodiment, the printing systems disclosed herein can be integrated in such a manner that the printing systems operate as a unique system configured specifically for function of printing (e.g., three-dimensional printing), and any associated computing devices of the printing systems operate as specific use computers for purposes of the claimed system, and not general use computers. In an embodiment, at least one associated computing device of the printing systems operate as specific use computers for purposes of the claimed system, and not general use computers. In an embodiment, at least one of the associated computing devices of the printing systems are hardwired with a specific ROM to instruct the at least one computing device. In an embodiment, one of skill in the art recognizes that the printing devices and printing systems effects an improvement at least in the technological field of three-dimensional printing.

The herein described components (e.g., steps), devices, and objects and the discussion accompanying them are used as examples for the sake of conceptual clarity. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, the reader can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

In some instances, one or more components can be referred to herein as “configured to.” The reader will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications can be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, the recited operations therein can generally be performed in any order. Examples of such alternate orderings can include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, the various aspects and embodiments disclosed herein are for purposes of illustration and are not intended to be limiting, with the true scope and spirit being indicated by the following claims.

What is claimed is:

1. A printing system, comprising:
at least one material reservoir configured to store one or more materials;
one or more dispense elements coupled to the at least one material reservoir, the one or more dispense elements including at least one dispense aperture and configured to controllably dispense the one or more materials onto a region of interest;
at least one flushing agent reservoir configured to store one or more flushing agents, the one or more flushing agents configured to prepare the region of interest to have the one or more materials dispensed thereon;
one or more flushing elements coupled to the at least one flushing agent reservoir, the one or more flushing elements including at least one flushing aperture, the one more flushing elements configured to dispense one or more flushing agents through the at least one flushing aperture towards the region of interest; and
a controller including control electrical circuitry that is operably coupled to at least the one or more dispense elements, the control electrical circuitry configured to at least direct dispensing of the one or more materials from the one or more dispense elements.

2. The printing system of claim 1, wherein the one or more flushing agents include one or more cleaning agent configured to remove one or more substances from at least one of the region of interest.

3. The printing system of claim 1, wherein the one or more flushing agents includes one or more antimicrobial agents configured to destroy microorganisms on the region of interest.

4. The printing system of claim 1, wherein the one or more flushing agents include one or more sterilizing agents configured to destroy microorganisms.

5. The printing system of claim 1, wherein the one or more flushing agents include one or more biocidal agents configured to destroy substantially all living matter on the region of interest.

6. The printing system of claim 1, wherein the one or more flushing agents include one or more agents that degrade or destroy organic matter on the region of interest.

7. The printing system of claim 1, wherein the one or more flushing agents include one or more corrosive agents.

8. The printing system of claim 1, wherein the one or more flushing agents include at least one of one or more inert agents, a liquid absorption material, medicament, a non-stick material, a binder, or a saccharide solution.

9. The printing system of claim 1, wherein the one or more flushing agents include a drying agent.

10. The printing system of claim 1, wherein the one or more flushing agents include a flushing gas.

11. The printing system of claim 11, wherein the flushing gas includes at least one of air, oxygen, nitrogen, argon, carbon dioxide, an aerosol, an oxidizing agent, vaporized hydrogen peroxide, ozone, nitrogen dioxide, or ethylene oxide.

12. The printing system of claim 1, wherein the one or more flushing agents include a flushing liquid.

13. The printing system of claim 12, wherein the flushing liquid includes water, a saline solution, a saccharide solution, an oxidizing agent, a hydrogen peroxide solution, a superoxidized water, an alcohol solution, a bleach solution, an acidic solution, a basic solution, glutaraldehyde, a medicament, a liquid binder, or a non-stick solution.

14. The printing system of claim 1, wherein the one or more flushing agents are pressurized.

15. The printing system of claim 1, wherein the one or more flushing elements include a tube, a microconduit, or a nozzle.

16. The printing system of claim 1, wherein the one or more flushing elements are configured to controllably dispense the one or more flushing agents, wherein the control electrical circuitry is coupled to the one or more flushing elements and configured to direct dispensing of the one or more flushing agents from the one or more dispense elements.

17. The printing system of claim 1, further including a printing head configured to support the one or more dispense elements and the one or more flushing elements a distance adjacent to or proximate to the region of interest.

18. (canceled)

19. (canceled)

20. The printing system of claim 1, further including one or more elongated members, at least one of the one or more dispense elements or the one or more flushing agents is coupled to the one or more elongated members.

21. The printing system of claim 20, wherein the one or more elongated members are at least one of flexible, rigid, or semi-rigid.

22. The printing system of claim 20, wherein the one or more elongated members include one or more actuators configured to move the one or more elongated members in one or more directions.

23. The printing system of claim 20, wherein the one or more elongated members include one or more actuators configured to controllably move the one or more elongated members in one or more directions responsive to one or more directions from the control electrical circuitry.

24. The printing system of claim 23, wherein the one or more actuators include a pneumatic actuator, a hydraulic actuator, a piezoelectric actuator, an electroactive polymer actuator, or a shape memory material actuator.

25. The printing system of claim 1, further including one or more sensors configured to detect at least one characteristic of the region of interest.

26. The printing system of claim 25, wherein the one or more sensors include a hydration sensor, a temperature sensor, an optical sensor, a biosensor, or a chemical sensor.

27. The printing system of claim 1, wherein the one or more materials includes at least one of a natural material, a synthetic material, a metallic material, a ceramic material, an organic material, a non-organic material, or a biological material.

28. The printing system of claim 27, wherein the biological material includes tissues, cells, transfected cells, or cell products.

29. The printing system of claim 1, wherein the one or more materials includes a nano-material, liposomes, or medicament.

30. (canceled)

31. (canceled)

32. The printing system of claim 1, wherein the region of interest is wet or dry.

33. The printing system of claim 1, wherein the region of interest includes a biological region of interest.

34. The printing system of claim 33, wherein the region of interest includes a region of a plant

35. The printing system of claim 1, wherein the region of interest includes a body of a living subject.

36. The printing system of claim 1, wherein the region of interest is an internal region of interest of a body of a living subject.

37. The printing system of claim 1, wherein the region of interest includes a non-organic region of interest.

38. The printing system of claim 1, wherein the one or more flushing elements are positioned and configured to dispense the one or more flushing agents through the at least one flushing aperture towards a portion of an at least partially printed object, the at least partially printed object formed from the one or more materials dispensed by the one or more dispense elements.

39. The printing system of claim 1, further including memory operably coupled to the controller, the memory including a program with instructions thereon for operating the printing system.

40. A method, comprising:
positioning one or more flushing elements adjacent to or proximate to a region of interest, the one or more flushing elements including at least one flushing aperture;
dispensing one or more flushing agents through the at least one flushing aperture to prepare the region of interest to have one or more materials printed thereon;
positioning one or more dispense elements adjacent to or proximate to the region of interest, the one or more flushing elements including at least one dispense aperture;
responsive to direction from control electrical circuitry, controllably dispensing the one or more materials from the one or more dispense elements onto the region of interest.

41. The method of claim 40, wherein the act of positioning one or more flushing elements adjacent to or proximate to the region of interest occurs substantially concurrently with the act of positioning one or more dispense elements adjacent to or proximate to a region of interest.

42. The method of claim 40, wherein the act of dispensing one or more flushing agents through the at least one flushing aperture to prepare the region of interest to have one or more materials printed thereon occurs prior to the act of controllably dispensing the one or more materials from the one or more dispense elements onto the region of interest.

43. The method of claim 40, wherein the act of dispensing one or more flushing agents through the at least one flushing aperture to prepare the region of interest to have one or more materials printed thereon occurs substantially concurrently with the act of controllably dispensing the one or more materials from the one or more dispense elements onto the region of interest.

44. The method of claim 40, wherein dispensing one or more flushing agents through the at least one flushing aperture to prepare the region of interest to have one or more materials printed thereon includes, responsive to direction from the control electrical circuitry, controllably dispensing the one or more flushing agents through the at least one flushing aperture to prepare the region of interest to have one or more material printed thereon.

45. The method of claim 40, wherein:
the one or more flushing elements includes a plurality of flushing elements; and
controllably dispensing the one or more flushing agents through the at least one flushing aperture includes independently dispensing the one or more flushing agents from each of the plurality of flushing elements.

46. The method of claim 40, wherein dispensing one or more flushing agents through the at least one flushing aperture includes dispensing a flushing gas.

47. The method of claim 40, wherein dispensing one or more flushing agents through the at least one flushing aperture includes dispensing a flushing liquid.

48. The method of claim 40, wherein dispensing one or more flushing agents through the at least one flushing aperture includes dispensing the one or more flushing agents which remove one or more substances from the region of interest.

49. The method of claim 40, wherein dispensing one or more flushing agents through the at least one flushing aperture includes dispensing the one or more flushing agents that destroy one or more microorganisms on the region of interest.

50. The method of claim 40, wherein dispensing one or more flushing agents through the at least one flushing aperture includes dispensing the one or more flushing agents that inhibit one or more microorganisms on the region of interest.

51. The method of claim 40, wherein dispensing one or more flushing agents through the at least one flushing aperture includes dispensing the one or more flushing agents that destroys substantially all organic matter on the region of interest.

52. The method of claim 40, wherein dispensing one or more flushing agents through the at least one flushing aperture includes dispensing the one or more flushing agents including one or more corrosive agents towards the region of interest.

53. The method of claim 40, further including responsive to direction from the control electrical circuitry, controllably actuating one or more elongated members to controllably steer the one or more flushing elements, wherein the one or more elongated members include one or more actuators, and the one or more flushing elements are coupled to the one or more elongated members.

54. The method of claim 40, wherein dispensing one or more flushing agents through the at least one flushing aperture includes dispensing the one or more flushing agents from one or more flushing agent reservoirs that store the one or more flushing agents.

55. The method of claim 40, wherein controllably dispensing the one or more materials from the dispense elements onto the region of interest includes controllably dispensing at least one of a natural material, a synthetic material, metallic material, a ceramic material, an organic material, a non-organic material, or a biological material.

56. The method of claim 40, further including detecting at least one characteristic about the region of interest using one or more sensors.

57. (canceled)

58. (canceled)

59. (canceled)

60. (canceled)

61. (canceled)

62. (canceled)

63. A reversibly attachable cartridge for a printing system, the reversibly attachable cartridge comprising:
at least one flushing agent reservoir configured to store one or more flushing agents, the one or more flushing agents configured to prepare a region of interest to have one or more materials dispensed thereon;
one or more flushing elements coupled to the at least one flushing agent reservoir, the one or more flushing elements including at least one flushing aperture, the one more flushing elements configured to dispense one or more flushing agents through the at least one flushing aperture to prepare the region of interest to receive one or more materials dispensed from one or more dispense elements;
one or more conduits fluidly coupling the at least one flushing agent reservoir with the one or more flushing elements; and
a housing configured to at least partially enclose the at least one flushing agent reservoir, the one or more flushing elements, and the one or more conduits, the housing further configured to be communicably coupled to and reversibly attached to the printing system.

64. (canceled)

65. (canceled)

66. (canceled)

67. (canceled)
